(19) United States
(12) Patent Application Publication
(10) Pub. No.: US 2018/0326723 A1
(43) Pub. Date: Nov. 15, 2018

(54) LIQUID EJECTING HEAD

(71) Applicant: CANON KABUSHIKI KAISHA, Tokyo (JP)

(72) Inventors: Takanobu Manabe, Oita-shi (JP); Kenji Fujii, Yokohama-shi (JP); Hirohisa Fujita, Saitama-shi (JP); Keisuke Kishimoto, Yokohama-shi (JP); Yoshinori Tagawa, Yokohama-shi (JP); Hideo Saikawa, Machida-shi (JP); Yasushi Iijima, Tokyo (JP); Kenji Yabe, Yokohama-shi (JP); Kyosuke Toda, Kawasaki-shi (JP); Yosuke Takagi, Yokohama-shi (JP); Hiroyuki Murayama, Yokohama-shi (JP)

(21) Appl. No.: 15/968,019

(22) Filed: May 1, 2018

(30) Foreign Application Priority Data
May 9, 2017 (JP) 2017-092987

(51) Int. Cl. B41J 2/14

(52) U.S. Cl. CPC B41J 2/1433

(57) ABSTRACT

The present invention provides a liquid ejecting head in which a chip crack is unlikely to occur. To achieve this, a liquid ejecting head includes an element substrate having energy generating elements arranged on the front face of the element substrate in its longitudinal direction and a channel member having ejection ports formed to correspond to the energy generating elements, respectively. In the element substrate, a supply port for supplying liquid is formed so as to pierce through from a back face to a front face of the element substrate, and inside the supply port, a beam is formed at a position closer to an end of the supply port rather than a center thereof in its longitudinal direction to connect facing inner walls of the supply port in its lateral direction.

### BACKGROUND OF THE INVENTION

### Field of the Invention

The present invention relates to a liquid ejecting head.

### Description of the Related Art

As a substrate used for a liquid ejecting head, there is a substrate formed by bonding together a channel member in which a plurality of ejection ports and a plurality of channels leading liquid thereto are formed and an element substrate in which elements to generate energy for ejecting liquid are laid out. In the element substrate, a supply port for supplying liquid which is common to all the channels of the channel member is formed as an opening that pierces through the element substrate.

Japanese Patent Laid-Open No. 2007-269016 discloses a method of stably forming a desired supply port by forming a non-through hole by laser processing on an element substrate made of silicon and then performing anisotropic etching. Meanwhile, Japanese Patent Laid-Open No. 2010-142972 discloses a method of forming a beam on the inner walls of a supply port upon its formation by using anisotropic etching. Even if a hollow supply port is configured to extend in a longitudinal direction of a substrate, the formation of one or more beams on its inner walls allows improved mechanical strength of a liquid ejecting head.

### SUMMARY OF THE INVENTION

According to an aspect of the present invention, there is provided a liquid ejecting head comprising: an element substrate including energy generating elements for ejecting liquid that are arranged on a front face of the element substrate in its longitudinal direction, and a supply port formed to pierce through from a back face of the element substrate to the front face for commonly supplying liquid to each of the energy generating elements; and a channel member including ejection ports formed to correspond to the energy generating elements, respectively, for ejecting liquid, wherein, inside the supply port, a beam is formed at a position closer to an end of the supply port rather than a center thereof in the longitudinal direction to connect facing inner walls of the supply port in its lateral direction, and where a length of the supply port in the longitudinal direction is denoted as L1 and a distance between the end and a center of the beam in the longitudinal direction is denoted as L2, L2/L1≤0.240 is satisfied.

Further features of the present invention will become apparent from the following description of exemplary embodiments with reference to the attached drawings.

### BRIEF DESCRIPTION OF THE DRAWINGS

FIG. 1 is a diagram showing an example of a substrate for a liquid ejecting head;

FIG. 2 is a diagram showing a configuration of an assembly of the liquid ejecting head;

FIGS. 3A to 3D are diagrams showing processes of forming a supply port and a beam on an element substrate;

FIGS. 4A to 4C are diagrams showing the element substrate in which etching processing has been completed;

FIG. 5 is a diagram for illustrating a suitable position of forming the beam in the element substrate;

FIGS. 6A to 6C are diagrams showing variations in the positions and numbers of beams to be provided;

FIGS. 7A and 7B are configuration diagrams of the liquid ejecting head used for verification;

FIGS. 8A to 8C are diagrams showing a modification in the case of providing the beam at a location on one side;

FIGS. 9A to 9C are diagrams showing another modification in the case of providing the beams at two locations on both sides;

FIGS. 10A to 10C are diagrams showing still another modification in the case of providing the beams at four locations; and

FIG. 11 is a table showing a result of verifying the state of chip crack occurrence.

### DESCRIPTION OF THE EMBODIMENTS

In a liquid ejecting head having a large heat generating amount due to the use of, for example, an electrothermal transducer for an energy generating element, a chip crack may occur due to a difference in thermal expansion between a channel member and an element substrate. Moreover, such a chip crack is likely to occur on a specific location of the element substrate.

However, in Japanese Patent Laid-Open No. 2010-142972 which is directed to the improvement of the mechanical strength of the entire liquid ejecting head, one beam is provided on the central part of the supply port or multiple beams are provided at equal intervals within the supply port, and thus, such configurations are not necessarily adapted to locations in which a chip crack is likely to occur. Accordingly, even if beams are provided on the positions disclosed in Japanese Patent Laid-Open No. 2010-142972, a chip crack may occur.

The present invention is made to resolve the above problem. Accordingly, an object of the present invention is to provide a liquid ejecting head in which a chip crack is unlikely to occur.

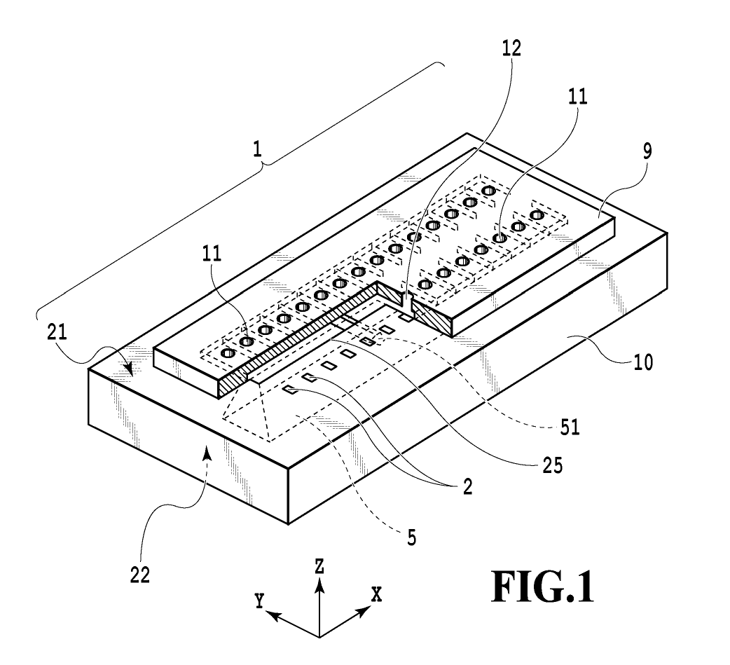

FIG. 1 is a diagram showing an example of a liquid ejecting head substrate 1 (hereinafter simply referred to as the substrate 1) that can be used in the present embodiment. The substrate 1 is configured to include an element substrate 10 having a flat plate shape and a channel member 9 stacked thereon in a Z direction in the diagram. On the front face of the channel member 9, two ejection port arrays each composed of a plurality of ejection ports 11 aligned in an X direction are aligned in a Y direction. Inside the channel member 9, pressure chambers 12 leading liquid to the respective ejection ports 11 and a channel 25 shared by and connected to all the individual pressure chambers 12 are formed. As a material for such a channel member 9, high mechanical strength as a structural material, adhesiveness to the element substrate 10, liquid-resistance property (e.g., ink-resistance property), and further, resolution for finely patterning the ejection ports 11 are required. As a specific material, thermosetting resin or the like is employed.

On a front face (first face 21) of the element substrate 10, energy generating elements 2 for generating energy to eject liquid are arranged on positions corresponding to the individual ejection ports 11 and pressure chambers 12. Further, in the element substrate 10, a slit-shaped supply port 5 extending in the X direction which is pieced through from the front face (first face 21) to a back face (second face 22) and which is connected to the channel 25 of the channel member 9 on the first face 21 is formed. As such an element substrate 10, it is preferable that a silicon substrate formed with silicon be used. Particularly, in the present embodiment, it is preferable that the silicon substrate having a surface of crystal orientation of (100) and having a thickness of 580 μm to 750 μm be used.

Liquid supplied to the supply port 5 from the second face 22 of the element substrate 10 is lead to the individual pressure chambers 12 via the channel 25 of the channel member 9. Moreover, once voltage pulses are applied to the energy generating elements 2 according to respective ejection signals, liquid that contacts the energy generating elements 2 is rapidly heated to produce foam growing energy along with film boiling and the liquid is ejected as droplets from the ejection ports 11.

Inside the supply port 5, a beam 51 that connects inner walls facing each other in the Y direction is provided on at least one location in the X direction. The beam 51 is provided at a part of the inner walls of the supply port 5 in the Z direction, and the liquid that flows into the supply port 5 can be merged at around the beam 51.

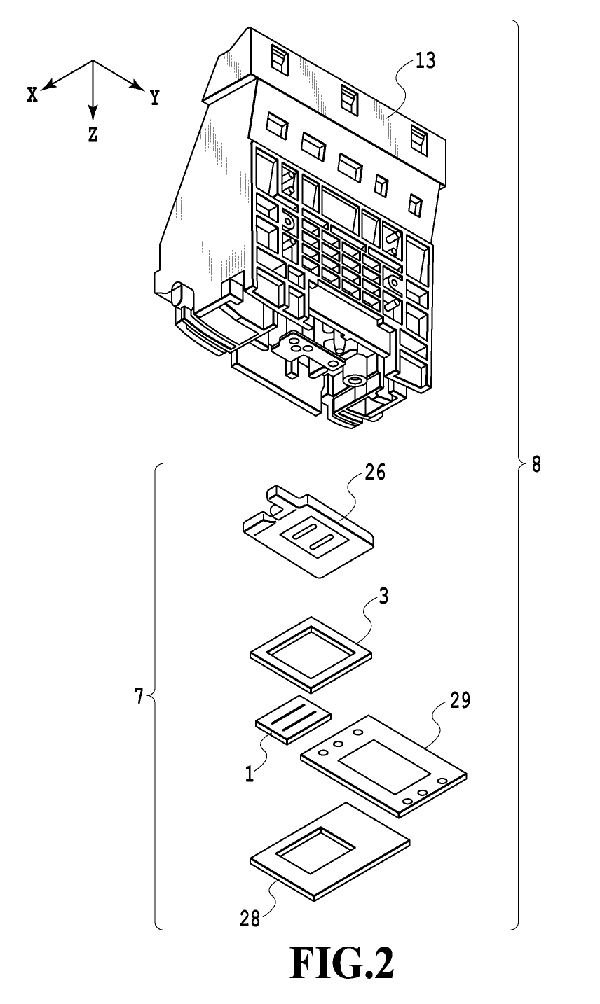

FIG. 2 is a diagram showing a configuration of an assembly of the liquid ejecting head 8 using the liquid ejecting head substrate 1 shown in FIG. 1. A face of the liquid ejecting head substrate 1 opposite the ejection ports 11, that is, the second face 22 of the element substrate is joined to and supported by a support member 26. Moreover, to the periphery of the substrate 1, a plate 3 which includes an aperture to surround the substrate 1 and which alleviates a gap between the support member 26 and the substrate 1 is joined. To the plate 3, an electrical wiring tape 28 which includes an aperture to surround the substrate 1 and which is configured to send electrical signals to the substrate 1 is joined, and further, to the electrical wiring tape 28, a connection substrate 29 is electrically connected. A configuration in which the support member 26, the plate 3, the substrate 1, the wiring tape 28, and the wiring connection substrate 29 are altogether joined forms a liquid ejecting head unit 7. This liquid ejecting head unit 7 is further combined with a sub-tank 13 that stores liquid to finally form a liquid ejecting head 8.

A detailed description on an assembly process of the liquid ejecting head unit 7 will be given below. First of all, the substrate 1 and the plate 3 are made to adhere to the support member 26. Then, the wiring tape 28 and the wiring connection substrate 29 are electrically connected to the plate 3 by using inner lead bonding (ILB). Next, to the periphery of the substrate 1, that is, a gap between the substrate 1 and the plate 3, a first sealing agent for protecting the gap from ink and foreign matters is applied. Further, after the first sealing agent is cured, a second sealing agent (ILB sealing agent) for preventing corrosion of wirings and electrical shortings, for example, at an electrical connection part is applied on the first sealing agent.

The first sealing agent which is to be firstly applied is required to flow through the gap formed between the substrate 1 and the plate 3 in a short time and to quickly fill the gap therebetween. The second sealing agent which is to be subsequently applied to form an exposed surface is required to be free from peeling caused by grinding with a wiper or the like for cleaning the face in which the ejection ports 11 are arranged and by the contact with paper or the like in the actual operation of the liquid ejecting head 8. To be more specific, it is preferable that an epoxy resin which is cured by heat or light be used.

In the liquid ejecting head 8 shown in FIG. 2, liquid is supplied to the individual pressure chambers 12 arranged on the substrate 1 from the sub-tank 13 via the support member 26, and ejection signals are inputted to the individual energy generating elements 2 arranged on the substrate 1 via the wiring connection substrate 29 and the wiring tape 28. As a result of the individual energy generating elements 2 being driven in accordance with the respective ejection signals, a liquid droplet is ejected from a corresponding ejection port 11 at a corresponding timing in the Z direction. In the case of an inkjet printing apparatus, for example, an ink droplet is ejected in the Z direction from a predetermined ejection port at a predetermined timing in accordance with a printing signal and an image is printed on a print medium disposed in the Z direction.

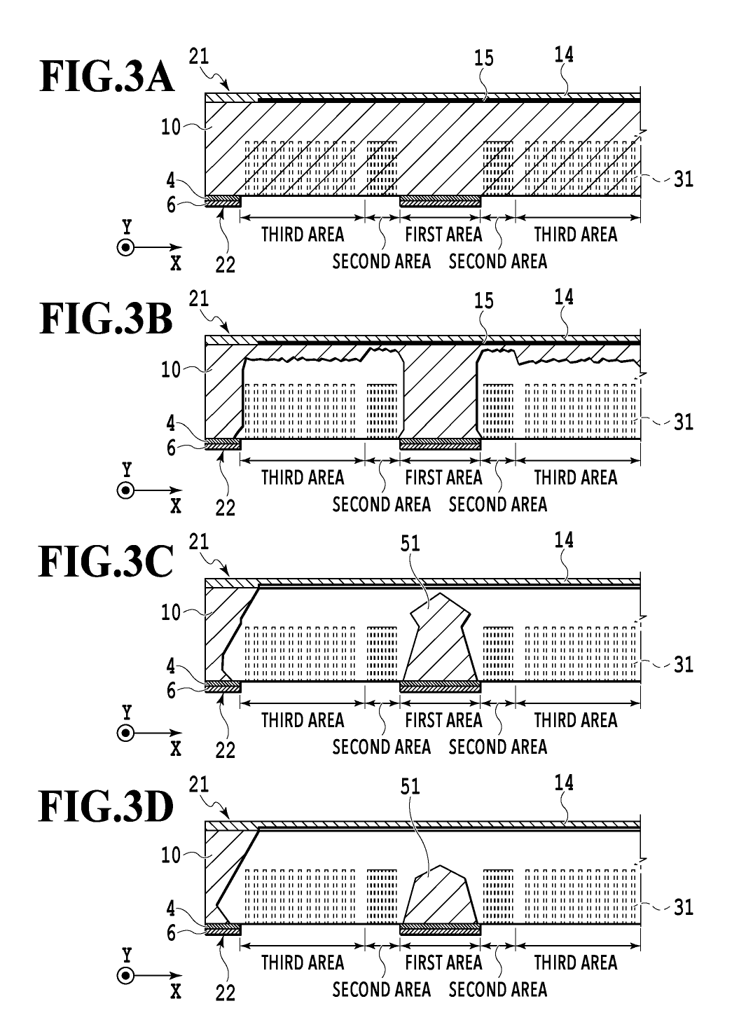

FIGS. 3A to 3D are diagrams illustrating processes of forming the supply port 5 and the beam 51 in the element substrate 10. For simplification, only a part of the element substrate 10 in a −X direction side is shown. It is preferable that the energy generating elements 2 be formed before forming the supply port 5. In the present embodiment, the supply port 5 is formed by applying the method disclosed in Japanese Patent Laid-Open No. 2010-142972. The detailed descriptions will be given below.

First of all, as shown in FIG. 3A, a sacrificial layer 15 is formed on the first face 21 of the element substrate 10. The first face 21 is a face where the energy generating elements 2 are arranged and is on a side that contacts the channel member 9. The sacrificial layer 15 is, in an etching process to be performed afterwards, a layer for controlling a shape (opening dimensions) of the supply port 5 in the first face 21 in order to form the beam 51 and the inner walls of the supply port 5 in desired shapes. The sacrificial layer 15 should preferably be a material having an etching speed higher than that of the substrate 1, and an Al—Si alloy, Al—Cu alloy, and Cu, for example, can be used for the sacrificial layer 15. An effect equivalent to the above can be obtained by providing a gap part instead of the sacrificial layer 15. The sacrificial layer 15 is formed only in an area of the first face 21 that corresponds to an area where the supply port 5 is intended to be formed. To be more specific, the sacrificial layer 15 should preferably be about 5 mm to 40 mm in the X direction and about 200 μm to 1.5 mm in the Y direction.

On the entire area of the first face 21 further above the sacrificial layer 15, a passivation layer 14 (etching stop layer) having etching resistance is stacked. The passivation layer 14 is a layer for stopping the progress of etching, and SiO₂ and SiN, for example, can be used for the passivation layer 14. At a location where the sacrificial layer 15 is not provided, the passivation layer 14 is directly provided on the first face 21.

Meanwhile, the second face 22 which is located opposite the first face 21 is managed by dividing its area into a first area, second area, and third area in the X direction (the extending direction of the supply port 5). The first area corresponds to an area where the beam 51 is to be formed afterwards. The size of the first area in the X direction is adjustable based on the width of the beam 51 to be formed, but should preferably be about 600 μm to 3 mm. The second area is an area which is adjacent to the first area and which contributes to etching the beam 51 from the first face 21 side. As to the second area as well, its size in the X direction is adjustable based on the shape of the beam 51 to be formed, but should preferably be about 80 μm to 720 μm. The third area is an area which is apart from the first area and is adjacent to the second area and which is other than the above first and second areas. A plurality of first areas, second areas, and third areas can be provided in the X direction while satisfying the above positional relations for providing a plurality of beams 51 within the supply port 5.

In the second face 22, an oxide film 4 made of SiO₂, for example, is formed on the first area and an area where the supply port 5 is not formed, and further, a protective film 6 is formed thereon. As the protective film 6, a polyether amide resin, for example, can be used. However, the protective film 6 may not necessarily be provided.

In the second area and the third area, a plurality of non-through holes 31 are formed by irradiating those areas with laser light from the second face 22. The non-through holes 31 are a mechanism to lead etchant and to urge erosion of a silicon layer (silicon substrate) for the etching processing to be performed afterwards. It is preferable that the non-through hole have a diameter of about 5 μm to 100 μm and have a depth (the length in the Z direction) of about 40% to 95% of the thickness of the element substrate 10. As the arrangement condition of the non-through holes 31 will be described later in detail, the array density of the non-through holes in the second area is higher than that in the third area.

Once the processing for the element substrate 10 as described above has been completed to obtain the state shown in FIG. 3A, anisotropic etching is then performed from the second face 22. As etchant, strong alkaline solution such as TMAH and KOH may be used. In the present embodiment, the silicon layer of the first area in which the oxide film 4 is formed is not eroded, and, as shown in FIG. 3B, only the layer in the second area and the third area is eroded. In this case, the progress of etching in the second area having the higher array density of the non-through holes 31 is faster than in the third area having the lower array density of the non-through holes 31, and the etching in the second area approaches the sacrificial layer 15 in an early stage.

As etching further progresses after the state of FIG. 3B, the etchant reaches the sacrificial layer 15 formed on the first face in the order of the second area and the third area. The etchant having reached the sacrificial layer 15 further enters the first area from the first face side by further eroding the sacrificial layer 15. Accordingly, the part of the silicon layer corresponding to the first area is eroded from the first face side (i.e., +Z direction) and from both sides in ±X directions in which erosion has already been completed, thereby forming a shape having a plurality of faces corresponding to different crystal faces (FIG. 3C).

As etching further progresses after the state of FIG. 3C, a part of the remaining silicon layer gradually becomes smaller in the direction of the oxide film 4 on the first face as shown in FIG. 3D. Then, the etching ends at a timing at which the silicon layer becomes an appropriate size.

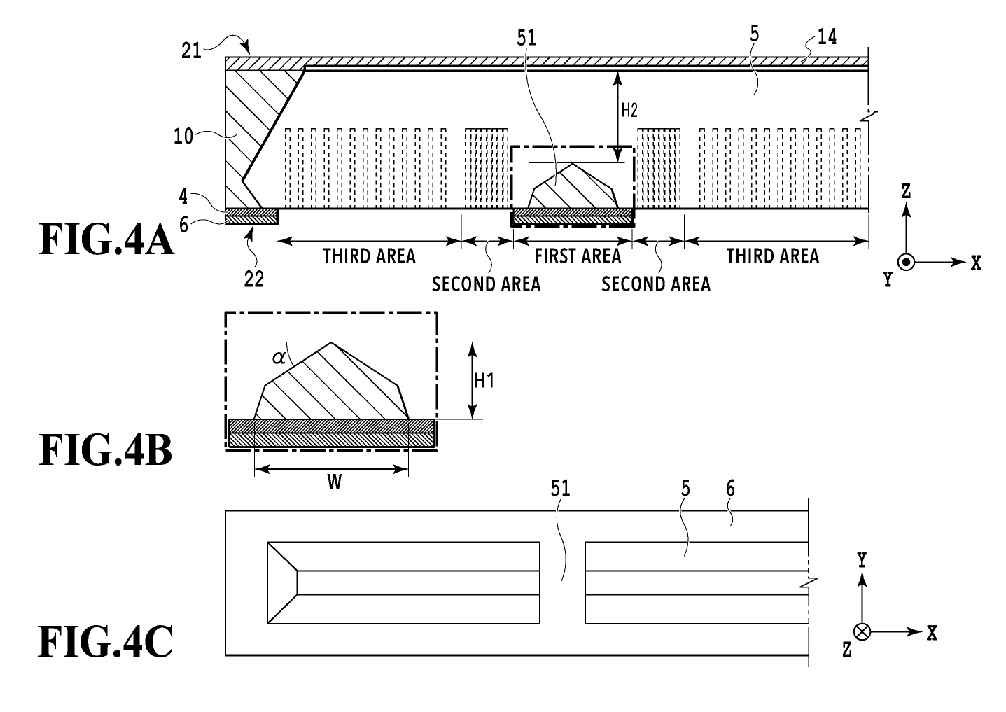

FIGS. 4A to 4C show the element substrate 10 in the state in which etching processing has been completed. An area eroded by the etching processing consequently becomes the supply port 5, and the remaining silicon layer consequently becomes the beam 51. FIG. 4A is a sectional view similar to those of FIGS. 3A to 3D, FIG. 4B is an enlarged view of the beam 51 part, and FIG. 4C is a top view of the element substrate 10.

The beam 51, which has a cross section of a pentagon, extends in a lateral direction (Y direction) of the supply port 5 so as to connect its facing inner walls in the Y direction. In the diagram, a size of the beam 51 in the X direction is denoted as W, its size in the Z direction as H1, an angle of a closest face to the first face with respect to the first face as α, and a distance between the first face to the beam 51 as H2.

In the case of the present embodiment, α is about 25 degrees, and the beam 51 is formed with a face that is different from Si (111) face. As such, the cross section of the beam 51 has a pentagonal shape because there are faces formed by high-speed etching and faces formed by low-speed etching. A shape of the cross section can be adjusted depending on dimensions of the first area in the X direction, the orientation and material of the element substrate 10, conditions of anisotropic etching, and the like. For instance, if etching is further progressed after the state of FIG. 4A, a beam of a triangular shape having a lower height in the cross section of FIG. 4A may also be formed.

A distance H2 from the first face 21 to the beam 51 affects the flow amount of liquid that can be supplied to the channel member 9 from the element substrate 10, and thus, it is preferable that a distance H2 be set based on the number of ejection ports 11 and on the aspect of ejection functions such as a refilling property in ejecting liquid from the ejection ports 11. A height H1 of the beam 51 is a value obtained by subtracting the value of H2 from the thickness of the element substrate 10, which also affects, together with a width W, mechanical strength required for the beam 51 itself. Accordingly, the dimension of H1, together with the width W, should preferably be adjusted. In addition, each of the dimensions for the beam 51 should preferably be determined by considering, for example, an extent and influence in which silicon is dissolved in liquid to be accommodated and the expected number of years to use the liquid ejecting head. To be more specific, it is preferable that the size W of the beam 51 in the X direction be 0.3 mm or more, the height H1 of the beam 51 be 0.1 mm or more, and the distance H2 from the first face 21 to the beam 51 be 0.05 mm or more.

After the etching processing described above has been completed, the passivation layer 14 is removed to complete the forming process of the supply port 5 and the beam 51 in the element substrate 10. The supply port 5 piecing through the element substrate 10 accommodates liquid from a relatively large opening arranged on the second face 22 side and discharges the liquid from a relatively narrow opening which is arranged on the first face 21 side and which is connected to the channel 25 of the channel member 9.

A detailed description on suitable arrangement conditions of the non-through holes 31 will be given below. In the silicon layer, the higher the array density of the non-through holes 31 is, adjacent non-through holes 31 are likely to combine in etching processing. In addition, the larger the length of the non-through holes 31 in a depth direction (Z direction) is, the earlier etchant reaches the sacrificial layer 15. Further, as for an area in which etching has reached the sacrificial layer 15 in a relatively early stage, the etchant progresses to the surroundings while eroding the sacrificial layer 15 to gradually contribute to the etching from the first face side. In other words, by adjusting the array density and the depth of the non-through holes 31 and the size of the first, second, and third areas, the supply port 5 and the beam 51 can be formed in desired shapes and dimensions.

In the present embodiment, etching in the second area is caused to reach the sacrificial layer 15 faster than that in the third area to urge etching for the first area from the first face side. To achieve this, the array pitch of the non-through holes 31 to be formed in the second area is set to be smaller (array density to be higher) than that in the third area. To be more specific, under the condition where a positional accuracy of machining by a laser machining apparatus is approximately ±10 μm and its alignment accuracy is approximately ±5 μm, for example, the non-through holes 31 having a diameter of approximately 10 μm are arranged at an interval of 40 μm to 90 μm in the second area and 100 μm to 550 μm in the third area.

Meanwhile, in the individual areas, the plurality of non-through holes 31 should preferably be arranged in a uniform manner. Particularly, based on the aspects of accuracy in forming the supply port 5 and its uniformity, it is preferable that the non-through holes 31 be formed substantially symmetrical with respect to a center line along the longitudinal direction (X direction) of the supply port 5. Details will be described as follows. For instance, an interval between adjacent non-through holes 31 in the second area is assumed to be x1, a distance between the end of the second area and its closest non-through hole 31 is assumed to be x2, an interval between adjacent non-through holes 31 in the third area is assumed to be x3, and the end of the third area and its closest non-through hole 31 is assumed to be x4. At this time, the following conditions should preferably be satisfied.

x2/2≤x1≤x2

x4/2≤x3≤x4

In the present embodiment, the array pitch of the non-through holes 31 to be formed in the second area is set to be smaller (x1<x3) than that in the third area for forming the beam 51 in the first area. Here, as to the X direction and Y direction, anisotropic etching on the Si (110) face or a face crystal-orientally equivalent to this is presumed to progress at a constant speed V. In this case, time until two adjacent non-through holes 31 are combined together in each of the areas is as follows:

Second area: T1=x1/2V

Third area: T2=x3/2V

A difference between the two areas is as follows:

ΔT=T2−T1=(x3−x1)/2V

This time can be regarded as a time for the progress of etchant from the second area to the first area via the sacrificial layer 15, that is, a time for forming the beam 51 from the first face 21 side. Even in the case of not providing the sacrificial layer 15, once etchant reaches the passivation layer 14, the solution then progresses along the first face 21 to form the beam 51 from the first face 21 side. In other words, the larger the difference between the array pitch x1 of the non-through holes 31 in the second area and the array pitch x3 of the non-through holes 31 in the third area is, time for the progress of etchant from the second area to the first area lengthens, thereby reducing the height H1 of the beam 51.

As such, the intervals x1 and x3 of the non-through holes 31 are set to be constant in each of the areas, but an interval of the non-through holes 31 in the X direction and an interval thereof in the Y direction may be different from each other. Further, under the intention of making etching processing in the second area progress faster than in the third area, the depth of the non-through holes 31 may also be optimized in each of the areas within the range of 40% to 95% of the thickness of the element substrate 10. In any case, by adjusting the array density and the depth of the non-through holes 31 in each of the areas and further the size of the first, second, and third areas, the shapes of the supply port 5 and beam 51 can be adjusted in various ways.

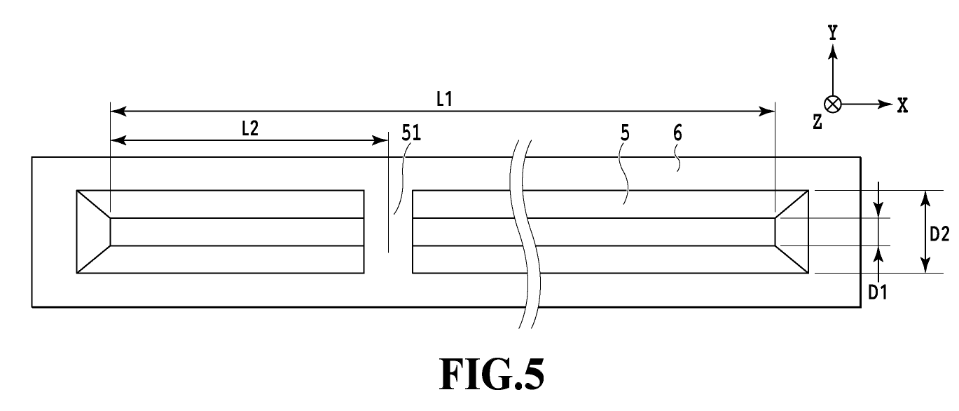

FIG. 5 is a diagram for illustrating a suitable position of forming the beam 51 in the element substrate 10. As already described above, the supply port 5 has a tapered shape, and the sizes between the opening in the first face 21 and the opening in the second face 22 are different. In FIG. 5, a width of the first face 21 of the supply port 5 in the Y direction is denoted as D1 and a width of the second face 22 is denoted as D2. D1 should preferably be 0.1 mm or more and 0.2 mm or less. D2 should preferably be 0.50 mm or more and 1.20 mm or less. Further, in the diagram, a length of the first face 21 of the supply port 5 in its longitudinal direction (X direction) is denoted as L1 and a distance between the end of the supply port 5 and the center of the beam 51 located closest to the end in the X direction is denoted as L2. L1 should preferably be 7.0 mm or more and 33.0 mm or less. If there is one beam 51, there are two ends of the supply port which are closest to the beam 51, but a distance of the closer end is assumed as L2 here.

Based on the above conditions, an object of the present embodiment is to provide the beam 51 on an effective position to avoid the occurrence of a chip crack. First of all, the chip crack will be briefly described below.

In fabricating the liquid ejecting head substrate 1, various heating processes are performed to cure organic materials such as a thermosetting resin. In this case, the degrees of contraction caused by heat between the channel member 9 and a sealing agent 38 are different, thereby applying a stress to the liquid ejecting head substrate 1. A flaw or a crack occurred on the liquid ejecting head substrate 1 due to this stress is referred to as a chip crack in the present specification. A risk of such chip crack occurrence and a location of occurrence vary depending on the size of the liquid ejecting head substrate 1, the size of the opening of the supply port 5, the number of the channel members 9 and the amount of the sealing agents 38 and their combination, and so on.

According to the study by the present inventors, a starting point of the chip crack relatively occurs on the end of the supply port 5, but by providing the beam on a position where the starting point is likely to occur, the occurrence of a chip crack is confirmed to be suppressed. In other words, in the case where an object is to suppress the occurrence of a chip crack, it is preferable that the beam 51 be firstly provided at a position near the end of the supply port in the X direction, prior to providing it at a center thereof. An example of a specific condition found in the study conducted by the present inventors such that the chip crack is unlikely to occur will be described below.

As for a condition of the supply port 5, if L1 and L2 satisfy Expression 1, it is effective to suppress the occurrence of a chip crack.

L2/L1≤0.24 (Expression 1)

Further, as for another condition of the supply port 5, it is preferable that Expression 2 be satisfied for D1 and D2.

4.0≤(D2/D1)≤10.0 (Expression 2)

Moreover, as for length L1 of the opening in the first face 21 of the supply port 5 in the X direction and length D1 in the Y direction, Expression 3 shown below should preferably be satisfied.

45≤(L1/D1)≤300 (Expression 3)

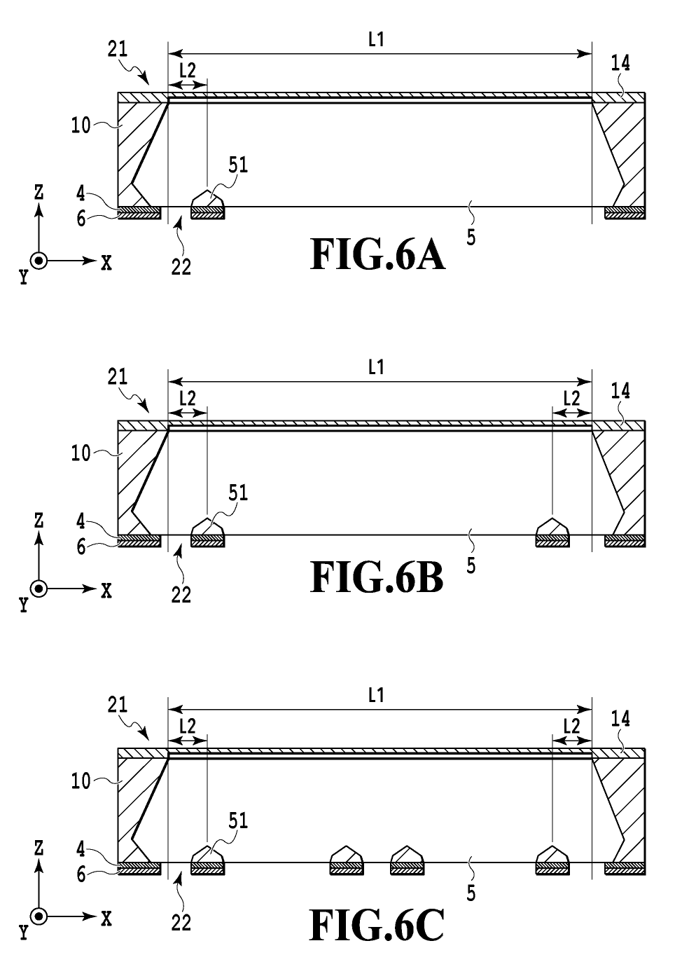

FIGS. 6A to 6C are diagrams showing variations in the positions and numbers of beams 51 to be provided which are effective in suppressing the occurrence of a chip crack. FIG. 6A shows the case where the beam 51 is provided at a location on one side with respect to the center of the supply port 5 in the X direction. FIG. 6B shows the case where the beams 51 are provided on both sides with respect to the center. FIG. 6C shows the case where the beams 51 are provided on both sides and two more around the central part. The occurrence of a chip crack can be effectively suppressed in any of those patterns as long as the relation of Expression 1 between a length L1 of the supply port 5 in the X direction and a distance L2 from the end of the supply port 5 to the beam 51 is satisfied. An effect of providing the beams 51 at positions that satisfy the above conditions will be described below.

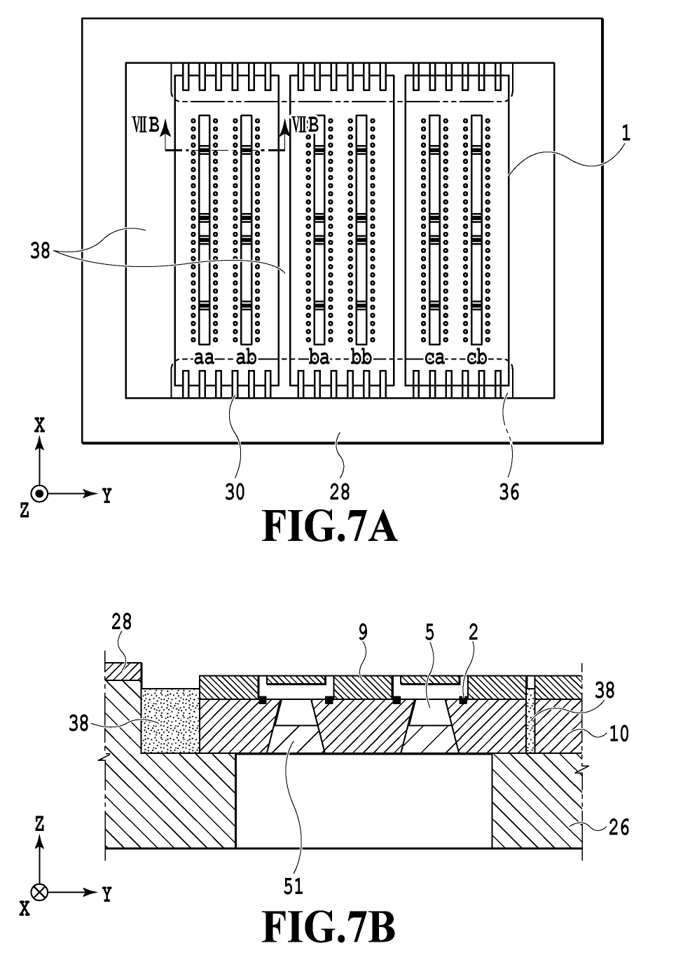

FIGS. 7A and 7B are configuration diagrams of the liquid ejecting head used for verification. The diagram shows the liquid ejecting head 8 in which three liquid ejecting head substrates 1 are aligned in parallel in the Y direction, in which the liquid ejecting head substrates 1 each having the supply ports 5 and the arrays of ejection ports sandwiching the supply ports further formed thereon are aligned in two arrays in the Y direction. Each of the liquid ejecting head substrates 1 has the size of 32.6 mm in the X direction, 3.5 mm in the Y direction, and 0.725 mm in the Z direction. The length L1 of the first face 21 of the supply port 5 in the X direction is 27 mm, the length D1 in the Y direction is 0.11 mm, and the length D2 of the second face 22 of the supply port 5 in the Y direction is 0.90 mm. In other words, D2/D1=0.9/0.11=8.18 holds, thereby satisfying Expression 2. Further, L1/D1=27/0.11=245.45 holds, thereby satisfying Expression 3.

FIG. 7A is a plane view viewing the liquid ejecting head 8 from an ejection port face side (first face 21 side), and FIG. 7B is a sectional view taken from line VIIB-VIIB in FIG. 7A. FIG. 7A shows the state in which the channel member 9 is removed, and FIG. 7B shows the state with the channel member 9.

As shown in FIG. 7B, the element substrate 10 is mounted on the support member 26, and its periphery is surrounded by the plate 3. Further above the plate 3 in the Z direction, the wiring tape 28 is joined, and on an ejection port face side (first face 21 side), the wiring tape 28 is in an exposed state as shown in FIG. 7A. The wiring tape 28 and the three element substrates 10 are electrically connected via leads 30.

For filling between the element substrates 10 and the plate 3 and between one element substrate 10 and another element substrate 10, the first sealing agent 38 that is lead to each clearance by capillary force is used. Further, an electrical connection part due to the leads 30 is coated by the second sealing agent. A clearance formed between the element substrates 10 and the plate 3 is larger than a clearance formed between the two adjacent element substrates 10, and is filled with more sealing agent. Accordingly, a stress occurred on the clearance of an outer side is larger than a stress occurred on the clearance of an inner side, and a chip crack is likely to occur on an ejection port array located on the outer side rather than on an ejection port array located on the inner side. In the case of FIG. 7A, assuming that six arrays of ejection ports are, from the left, aa, ab, ba, bb, ca, and cb, ejection port arrays having the highest possibility of chip crack occurrence are aa and cb. In the present verification example, by focusing on the ejection port arrays aa and cb, the states of chip crack occurrence in the case of changing L2 in various ways have been compared in each of the patterns illustrated in FIGS. 6A to 6C.

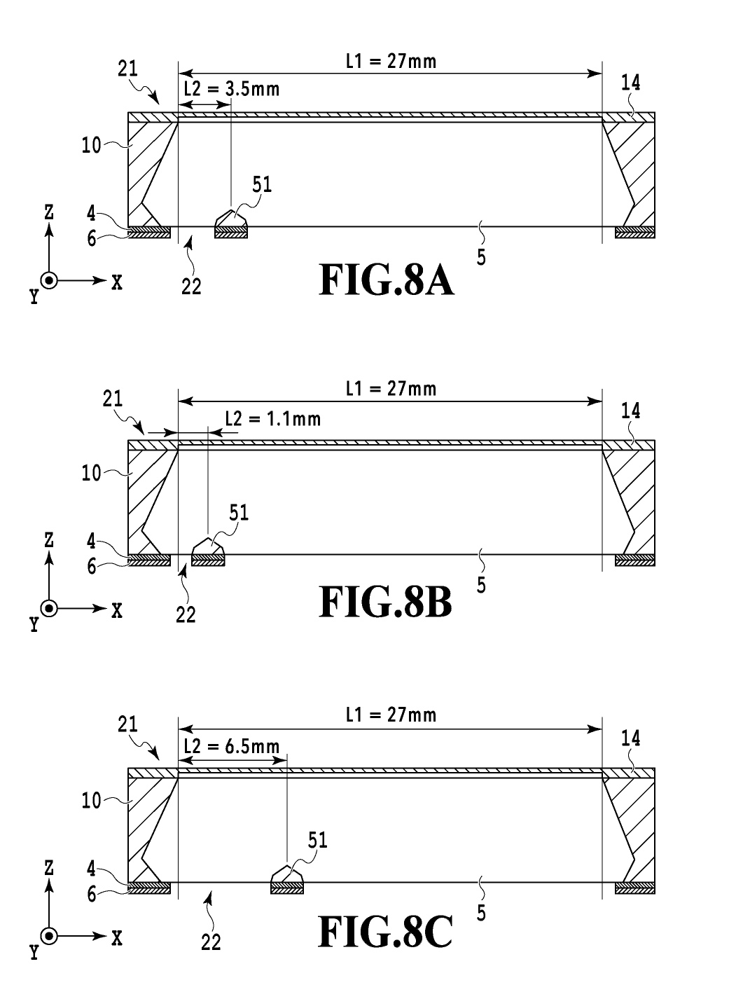

FIGS. 8A to 8C illustrate the case of changing L2 in variation based on the pattern of providing the beam 51 having a width being W=1.0 mm in the X direction at a one-side location in the X direction as in FIG. 6A. It is assumed that L2=3.5 mm in FIG. 8A, L2=1.1 mm in FIG. 8B, and L2=6.5 mm in FIG. 8C.

In FIG. 8A, L2/L1=3.5/27=0.1296≤0.240 holds, thereby satisfying Expression 1. In addition, in FIG. 8B, L2/L1=1.1/27=0.0407≤0.240 holds, thereby also satisfying Expression 1. As to FIG. 8C, L2/L1=6.5/27=0.2407>0.240 holds, thereby failing to satisfy Expression 1.

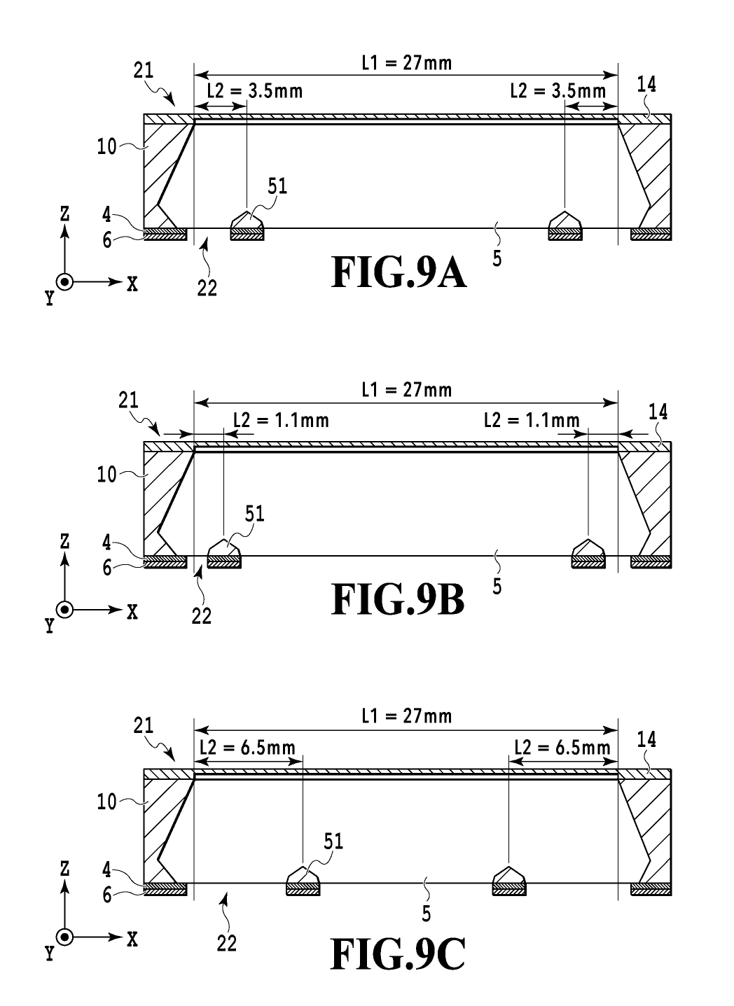

Meanwhile, FIGS. 9A to 9C illustrate the example of changing L2 in variation based on the pattern of providing two beams 51 each having a width being W=1.0 mm in the X direction at locations on both sides in the X direction in a symmetrical manner as in FIG. 6B. It is assumed that L2=3.5 mm in FIG. 9A, L2=1.1 mm in FIG. 9B, and L2=6.5 mm in FIG. 9C.

In this case as well, in FIG. 9A, L2/L1=3.5/27=0.1296≤0.240 holds, thereby satisfying Expression 1. In addition, in FIG. 9B, L2/L1=1.1/27=0.0407≤0.240 holds, thereby satisfying Expression 1. As to FIG. 9C, L2/L1=6.5/27=0.2407>0.240 holds, thereby failing to satisfy Expression 1.

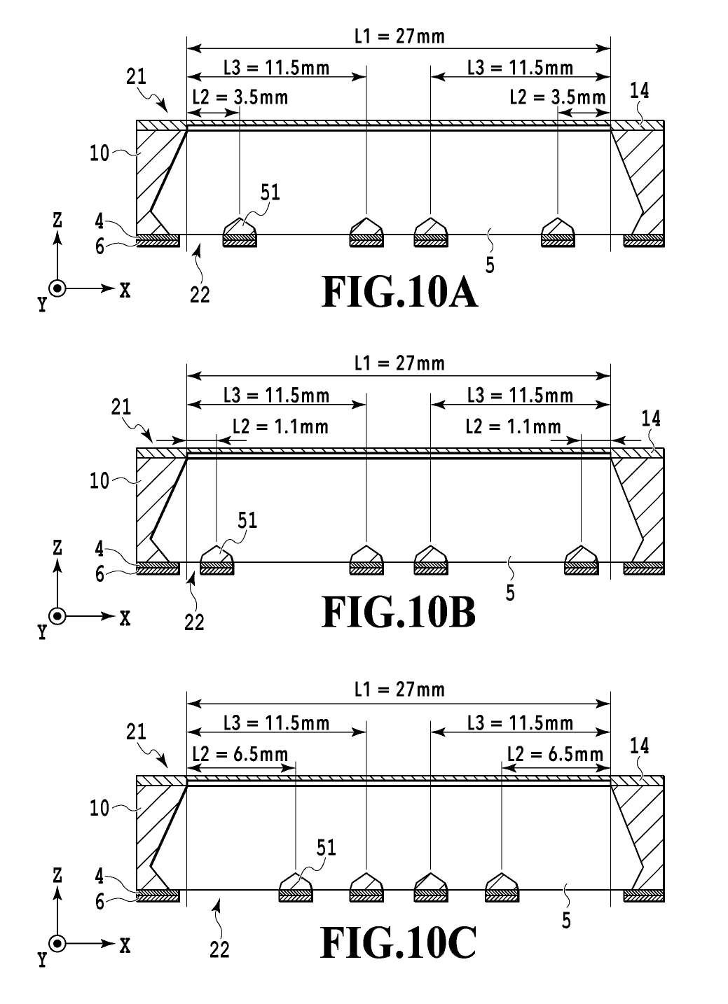

FIGS. 10A to 10C illustrate the example of changing L2 in variation based on the pattern of providing four beams 51 each having a width being W=1.0 mm in the X direction at four locations in the X direction in a symmetrical manner as in FIG. 6C. In FIG. 10A, it is assumed that a distance L2 from the end of the supply port to the closest beam 51 is 3.5 mm and a distance L3 from the end of the supply port to the next closest beam 51 is 11.5 mm. In FIG. 10B, it is assumed that L2=1.1 mm and L3=11.5 mm. In FIG. 10C, it is assumed that L2=6.5 mm and L3=11.5 mm.

In this case as well, in FIG. 10A, L2/L1=3.5/27=0.1296≤0.240 holds, thereby satisfying Expression 1. In addition, in FIG. 10B, L2/L1=1.1/27=0.0407≤0.240 holds, thereby also satisfying Expression 1. As to FIG. 10C, L2/L1=6.5/27=0.2407>0.240 holds, thereby failing to satisfy Expression 1.

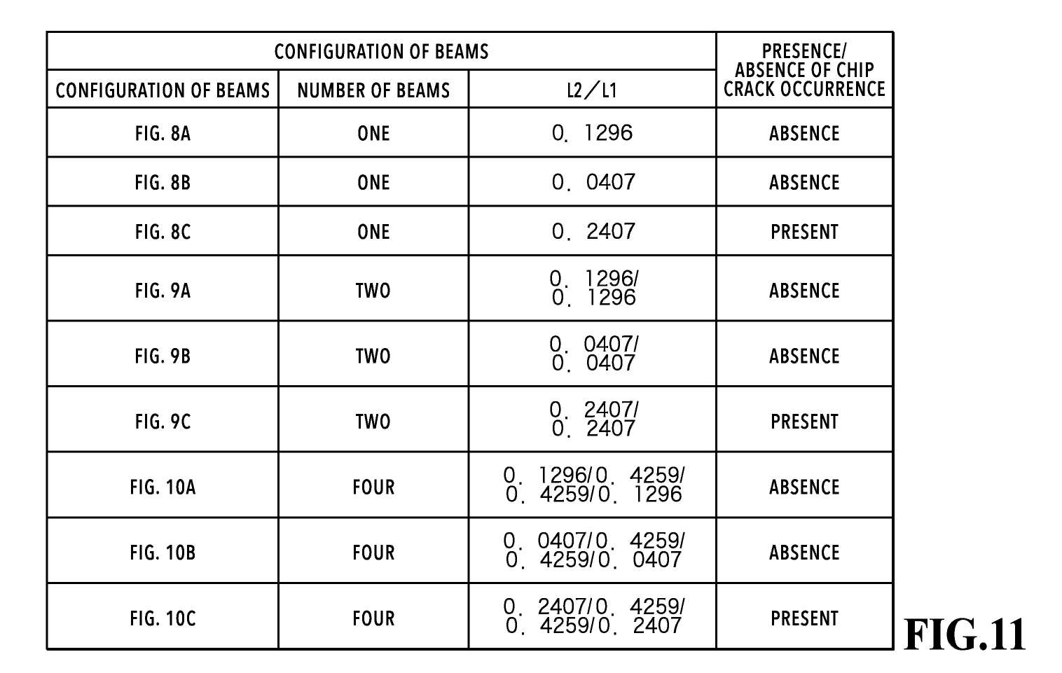

FIG. 11 is a table showing a result of verifying the state of chip crack occurrence for each of the examples shown in FIG. 8A to FIG. 10C. In all the cases, the liquid ejecting head having a configuration of arranging, in parallel, three arrays of element substrates 10, having respective beam patterns, as shown in FIGS. 7A and 7B has been used. The table shows the results of checking presence/absence of a chip crack by focusing on the ejection port arrays aa and cb after performing ejection operation from the individual element substrates for a predetermined number of times and for a predetermined duration. As to FIGS. 8A to 8C, the chip crack occurrence has been checked focusing only on the end side where the beam 51 is provided. As to FIGS. 9A to 9C and FIGS. 10A to 10C, the chip crack occurrence has been checked on the entire areas of the supply ports.

As recognized from the table, a chip crack has not been confirmed in all the patterns of FIGS. 6A to 6C as long as Expression 1 is satisfied, whereas a chip crack has been confirmed in the configuration in which Expression 1 is not satisfied. For instance, in the case of comparing FIG. 9A and FIG. 10C, the strength of the liquid ejecting head substrate itself is higher in the substrate of FIG. 10C where multiple beams 51 are relatively arranged around the center. However, a chip crack has occurred on the substrate of FIG. 10C where Expression 1 is not satisfied. As such, a position of a beam suitable for enhancing the strength of the liquid ejecting head substrate and a position of a beam suitable for suppressing the occurrence of a chip crack are not necessarily identical. Moreover, as long as at least one beam is formed on a position where Expression 1 is satisfied, the occurrence of a chip crack can be suppressed regardless of the presence/absence of beams formed on other locations or regardless of the positions and the number of such beams.

Incidentally, in the above verification example, Expression 1 has been presented as a suitable position L2 of the beam based on the supply port 5 that satisfies Expression 2 and Expression 3, but the present invention is not limited to the one that simultaneously satisfies the above three expressions. For instance, even with the supply port that does not satisfy Expression 2 and Expression 3, an effective position (L2) for suppressing the occurrence of a chip crack exists. It is evident that such a position preferably satisfies Expression 1, and the effect of the present invention can be obtained as long as a beam is at least at a position close to the end with respect to a center of the supply port in its longitudinal direction (X direction). In this case, the position, the number, the size, and the shape of the beam 51 may be changed in various ways. For instance, two or more beams that satisfy Expression 1 may be formed at the end of the same side in the X direction or may be formed on right and left sides in an asymmetrical manner. In any case, as long as one or more beams are provided at position(s) closer to the end rather than the center of the supply port in the X direction, the occurrence of a chip crack can be suppressed regardless of the presence/absence of beams formed on other locations or regardless of the positions and the number of such beams.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-092987, filed May 9, 2017, which is hereby incorporated by reference wherein in its entirety.

What is claimed is:

1. A liquid ejecting head comprising:
an element substrate including
energy generating elements for ejecting liquid that are arranged on a front face of the element substrate in its longitudinal direction, and
a supply port formed to pierce through from a back face of the element substrate to the front face for commonly supplying liquid to each of the energy generating elements; and
a channel member including ejection ports formed to correspond to the energy generating elements, respectively, for ejecting liquid, wherein,
inside the supply port, a beam is formed at a position closer to an end of the supply port rather than a center thereof in the longitudinal direction to connect facing inner walls of the supply port in its lateral direction, and
where a length of the supply port in the longitudinal direction is denoted as L1 and a distance between the end and a center of the beam in the longitudinal direction is denoted as L2,
L2/L1≤0.240 is satisfied.

2. The liquid ejecting head according to claim 1, wherein, where a length of the front face of the supply port in the lateral direction is denoted as D1 and a length of the back face thereof in the lateral direction is denoted as D2,
4.0≤(D2/D1)≤10.0
and
45≤(L1/D1)≤300
are further satisfied.

3. The liquid ejecting head according to claim 2, wherein the length D1 is 0.1 mm or more and 0.2 mm or less.

4. The liquid ejecting head according to claim 2, wherein the beam is formed only on one side with respect to a center of the supply port in its longitudinal direction.

5. The liquid ejecting head according to claim 2, wherein the beams are formed on both sides, respectively, with respect to the center of the supply port in its longitudinal direction.

6. The liquid ejecting head according to claim 5, wherein the beams are formed in a symmetrical manner with respect to the center in the longitudinal direction.

7. The liquid ejecting head according to claim 2, wherein the beam is formed on a side of the back face in the supply port.

8. The liquid ejecting head according to claim 2, wherein the element substrate is a silicon substrate formed with silicon.

9. The liquid ejecting head according to claim 2, wherein the length L1 is 7.0 mm or more and 33.0 mm or less.

10. The liquid ejecting head according to claim 1, wherein the beam is formed only on one side with respect to a center of the supply port in its longitudinal direction.

11. The liquid ejecting head according to claim 1, wherein the beams are formed on both sides, respectively, with respect to the center of the supply port in its longitudinal direction.

12. The liquid ejecting head according to claim 11, wherein the beams are formed in a symmetrical manner with respect to the center in the longitudinal direction.

13. The liquid ejecting head according to claim 1, wherein the beam is formed on a side of the back face in the supply port.

14. The liquid ejecting head according to claim 1, wherein the element substrate is a silicon substrate formed with silicon.

15. The liquid ejecting head according to claim 14, wherein the length L1 is 7.0 mm or more and 33.0 mm or less.
